(19) United States
(12) Patent Application Publication
(10) Pub. No.: US 2003/0046816 A1
(43) Pub. Date: Mar. 13, 2003

(54) Shaving razor having a heat sink razor head

(76) Inventor: Steve Kanzer, Miami, FL (US)

Correspondence Address: Charles M. Doyle, Esq., Lyon & Lyon, LLP, Suite 4700, 633 West Fifth Street, Los Angeles, CA, 90071-2066, US

(21) Appl. No.: 10/086,776

(22) Filed: Mar. 1, 2002

Related U.S. Application Data
(60) Provisional application No. 60/272,683, filed on Mar. 1, 2001.
(60) Provisional application No. 60/343,752, filed on Dec. 27, 2001.

(51) Int. Cl. B26B 21/14

(52) U.S. Cl. 30/32; 30/34.05; 30/50

(57) ABSTRACT

A shaving razor includes a razor housing comprising a heat sink element for holding thermal energy and releasing it in a controlled, sustained fashion to heat the shaving surface ahead of the razor blade.

This application claims priority to U.S. Provisional Application Serial No. 60/272,683, filed on Mar. 1, 2001, and to U.S. Provisional Application Serial No. 60/343,752, filed on Dec. 27, 2001, the entireties of which are hereby incorporated by reference.

### FIELD OF THE INVENTION

The present invention relates to a shaving razor. More particularly, the present invention relates to a shaving razor having a shaving razor head with a heat sink.

### BACKGROUND OF THE INVENTION

Many devices and methods exist for shaving facial hair. Most commonly used is the safety razor, which comprises a sharp blade held in a razor head. The blade is applied to the skin at a certain angle to cut the hair near the base of the hair shaft. However, safety razors, even when carefully used, often produce nicks and cuts in the skin. Therefore, most users also employ some combination of soap and skin lubricants, often in the form of a shaving cream, that is applied to the skin shortly before shaving is begun to soften the skin and hair and diminish the possibility of nicks and cuts. However, this practice does not completely eliminate the problem, and further comprises an additional step that must be performed before the actual shaving is begun.

An alternative approach is to heat the skin and/or the hair prior to shaving, to soften the surface or hair and make it more amenable to cutting. Many devices for heating skin and/or hair prior to shaving are known in the art. U.S. Pat. No. 4,253,013 (Mabuchi et al.) discloses a electric heating device for an electric shaver that fits closely over the shaver head to heat the electric shaver head and thereby cause the temperature of the electric razor head to rise. The heating device uses an electric heating element, typically incorporating nichrome wire, to generate heat in close physical proximity to the shaver head. Once the shaver head has reached a desired temperature, the heating device is removed or turned off, and the electric shaver used in the usual fashion. The heated razor head is thought to heat the skin and hair to be shaved, thereby softening the skin and hair and making them more amenable to cutting. However, such a system is expensive to manufacture and requires a power source, either AC or DC, for the heating device.

U.S. Pat. No. 5,065,515 (Iderosa) discloses a shaving razor having a heating means incorporated into the razor housing itself. The heating means is described as either a laser beam or a ceramic or metallic heating element that acts to apply heat to the hair prior to shaving. The heating means is located close to the razor blade, so that the heat transferred to the hair is not dissipated before it is cut. The heating element or laser beam is powered by a power source, either AC or DC. However, the heating means described in Iderosa are complicated and expensive, and further may present a possible electrical hazard. Moreover, the device is not suited for use in disposable razors.

U.S. Pat. No. 5,394,777 (Kozikowski) discloses a shaving razor that produces a stream of hot air running from a razor housing out through a shaver head onto a surface to be shaved ahead of a razor blade. The stream of hot air is created by a fan that directs a stream of air over a heating element, such as a nichrome wire. The stream of heated air is then channeled through the razor housing and exits out the face of the razor housing. Like the device of Iderosa, the device of Kozikowski is complicated and expensive, and can present hazardous conditions if electric elements are incorporated into the razor. Moreover, like the device of Iderosa, the device of Kozikowski is not suited for use in disposable razors. Therefore, there remains a need for a shaving razor that can easily and inexpensively apply heat to a surface to be shaved to improve the quality of the shaving process.

### SUMMARY OF THE INVENTION

The present invention is a safety razor having a razor housing comprising a heat sink element for holding thermal energy and releasing it in a controlled, sustained fashion to heat the shaving surface ahead of the razor blade.

It is an object of the present invention to provide a safety razor that comprises a razor blade, a razor housing for holding the razor blade, and a razor handle connected to the razor housing, wherein the razor housing comprising a heat sink material in a position to be in thermal contact with the skin of a user.

It is another object of the present invention to provide a safety razor containing a thermally conductive plastic, in which the thermally conductive plastic being in a position to be in thermal contact with the skin of a user.

It is another object of the present invention to provide a safety razor that comprises a razor blade, a razor housing for holding the razor blade, and a razor handle connected to the razor housing, wherein the razor housing comprising a thermally conductive plastic in a position to be in thermal contact with the skin of a user.

The above and other objects, features and advantages of the present invention will become apparent from the following description read in conjunction with the following Figure.

### BRIEF DESCRIPTION OF THE DRAWINGS

FIG. 1 is a drawing of a safety razor according to an embodiment of the present invention.

### DETAILED DESCRIPTION OF THE PREFERRED EMBODIMENTS

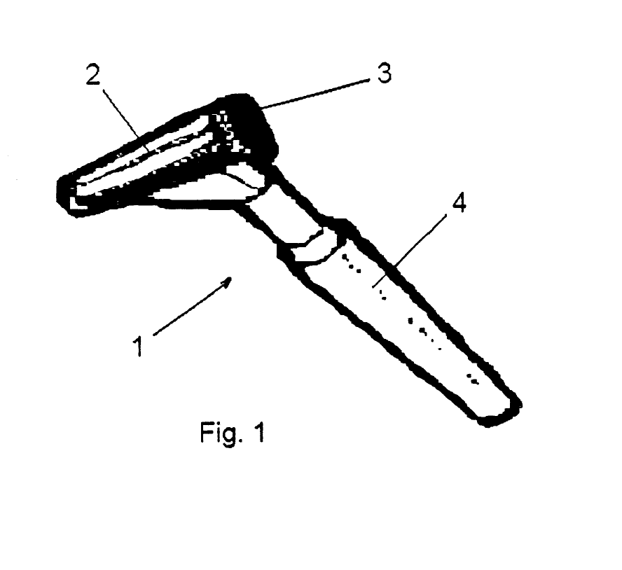

Referring now to FIG. 1, a safety razor 1 has a shaving razor blade 2 mounted on a razor head 3 that is connected in turn to a razor handle 4. The razor head 3 of the safety razor of the present invention is made or incorporates a substantial amount of a heat sink material. Moreover, the heat sink material is shaped to contact the skin or hair to be shaved before the blade. By doing so, heat may be transferred from the heat sink material to the skin or hair, softening it before the blade 2 cuts the hair. Commonly used heat sink materials include metal and metal composite materials, such as copper and copper composites (i.e., Cu₂O/Cu composites) and aluminum and aluminum composites. Heat sink materials may also include laminated composite materials, such as graphite in a cyanate ester matrix, or ceramic materials or ceramic composites. Heat sink materials may also comprise combinations or mixtures of any of the above.

The composition of the heat sink material is crucial to the success of the present invention. The heat sink material is such that it may be heated quickly to a temperature that is high enough to heat the skin to an appropriate temperature. The heat sink material should be such that it can obtain thermal energy from being submerged in hot water at a temperature that is within a range that can be comfortably applied to the skin. Alternatively, the razor head 3 may obtain thermal energy by being held under a running stream of warm or hot water. The heat sink material must be capable of being heated by immersion under water, or by contact with hot running water, of this temperature for a relatively short period of time, i.e., not more than 30 seconds, more preferably not more than 15 seconds, and still more preferably not more than 10 seconds. In addition, the heat sink material must also be such that it can transfer heat to the skin surface readily but in a slow and sustained fashion, i.e., slowly enough to avoid discomfort to the user or injury, i.e., burning the skin. Thus, the thermal conductivity of the material used as the heat sink is crucial—it must be high enough to apply heat to the surface of the skin or hair so as to heat the skin or hair to the appropriate temperature, but not so high as to release all the heat quickly. If the heat content of the material is too high, a painful burn could result. If the heat content of the material is too low, repeated rinses under hot water could be required.

In practice, the razor head 3 of the present invention is immersed in or held under a running stream of warm or hot water having a temperature at least that required to soften the skin for improved shaving until the heat sink material reaches a temperature within the preferred range. Preferably, the time required to bring the heat sink material in the razor head 3 to the desired temperature is no longer than that typically required to rinse the razor to use, i.e., on the order of a few seconds.

It is preferable that the entire shaving razor head 3 may made of the heat sink material. Alternately, a substantial portion of the razor head 3 may be made of the heat sink material. By “substantial portion”, it is meant that a sufficient portion of the razor head to accomplish the goal of the invention, i.e., to contact and heat the hairs and/or skin to soften them during the shaving process. The heat sink material may further be in the form of a strip along the face of the razor head 3 that contacts the skin ahead of the blade 2, such as is currently used to hold and dispense a lubricant on some razor models. However, if the heat sink material is formed as a strip, the strip still must not attain a temperature so high as to cause discomfort or physical injury, i.e., a burn, to the user upon contacting the skin.

In a preferred embodiment of the invention, the heat sink material may comprise a material capable of being mass produced inexpensively using injection molding techniques, for example. One such class of material are so-called “thermally conductive plastics”. Thermally conductive plastics are engineered to spread heat and dissipate thermal energy to the surrounding environment to a far greater degree than conventional plastics. Such plastics may also be injection molded, which reduces the cost of making plastic articles from such materials. Thermally conductive plastics include those available from Cool Polymers, Inc., Warwick, R.I., USA. Examples of the thermally conductive plastics available from Cool Polymers are (thermal conductivity measured in units of watts/meter °K (W/m °K): CoolPoly™ E2 (thermally conductive liquid crystalline polymer, W/m K=20), CoolPoly™ E200 (thermally conductive liquid crystalline polymer, W/m K=30), CoolPoly™ RB018 (thermally conductive Nylon 66, W/m K=15), CoolPoly™ RB019 (thermally conductive polycarbonate, W/m K=20), Coolpoly™ RB024 (E Series) (thermally conductive PC/ABS blend, W/m K=8), and CoolPoly™ RB020 (thermally conductive polyphenylene sulfide, W/m K=20). Other injection molding grade materials may include polymers or silicone based composite materials containing one or more thermally conductive materials such as metals such as zinc oxide or aluminum oxide for example or ceramic materials. The advantages of these materials are their low cost of raw materials, capability to be mass produced inexpensively via injection molding, flexibility in design and ability to be substituted for commonly used thermally insulative plastics and polymers without a significant amount of retooling. For purposes as used herein, a thermally conductive plastic means a material having a W/m K of greater than 0.4. For purposes as used herein, a thermally conductive injection molding grade material means a material capable of being mass produced via injection molding and having a W/m K of greater than 1.0.

Although the invention herein has been described with reference to particular embodiments, it is to be understood that these embodiments are merely illustrative of various aspects of the invention. Thus, those of skill in the art would understand that various modifications may be made in the illustrative embodiments and other arrangements may be devised without departing from the spirit and scope of the invention. Throughout this application various publications, patents and/or applications are cited. The entire contents of these publications, patents and/or applications are hereby incorporated by reference into the present application.

What is claimed is:

1. A safety razor, comprising:
a razor blade;
a razor housing for holding said razor blade;
a razor handle connected to said razor housing;
said razor housing comprising a heat sink material, said heat sink material being in a position to be in thermal contact with the skin of a user.

2. A safety razor containing a thermally conductive plastic.

3. A safety razor according to claim 2, wherein said thermally conductive plastic is a member selected from the group consisting of CoolPoly™ E2, CoolPoly™ E200, CoolPoly™ RB018, Coolpoly™ RB019, Coolpoly™ RB024, and Coolpoly™ RB020.

4. A safety razor containing a thermally conductive injection molding grade material that is in contact with the user's skin during the shaving process.

5. A safety razor, comprising:
a razor blade;
a razor housing for holding said razor blade;
a razor handle connected to said razor housing;
said razor housing comprising a thermally conductive plastic, said thermally conductive plastic being in a position to be in thermal contact with the skin of a user.

6. A safety razor according to claim 4, wherein said thermally conductive plastic is a member selected from the group consisting of Coolpoly™ E2, CoolPoly™ E200, CoolPoly™ RB018, Coolpoly™ RB019, CoolPoly™ RB024, and CoolPoly™ RB020.
